(19) United States
(12) Patent Application Publication
(10) Pub. No.: US 2004/0019520 A1
(43) Pub. Date: Jan. 29, 2004

(54) Business model for the sale of recorded media through the Internet and other distribution channels adapted to the acoustic print and/or replay system set up of the customer

(76) Inventor: Luis Felipe Guglielmucci, Santiago (CL)

Correspondence Address: LUIS FELIPE GUGLIELMUCCI, ENRIQUE BARRENECHEA 3820, MACUL, SANTIAGO, ., CL

(21) Appl. No.: 10/064,533

(22) Filed: Jul. 24, 2002

(51) Int. Cl. G06F 17/60

(52) U.S. Cl. 705/14

(57) ABSTRACT

The proposal constitutes a business model for selling recorded media, through the Internet and other channels, adapted to the acoustic print and replay system set up of the customer. The proposal's main objective is to sell edited copies of the original record in order to produce a richest experience for the customer, based on the unique characteristic of the customer's reproducer system and the acoustic characteristics of the customer's listening site. The proposal attempts to face the current media problems, specially the popular music industry, raised because the home appliances industry is nailed in the HIFI STEREO paradigm were innovation is coming from fancy designs, the Media Industry is finding hard to protect its copyrights due to the disruptive ways of exchange files provided by Internet and finally, because the talent source, the artists, especially the famous ones are looking at Internet as a much more profitable distribution channel.

### OTHER RELATED APPLICATIONS

Referenced-applications

THX DTS

### BACKGROUND OF THE INVENTION

Sources of Inspiration

The recorded music is a high technology soundtrack, professionally shaped, mixed, equalized and cleaned. This product goes into the Entertainment Industry where it's promoted, branded and sold. There is also, a House Appliance Industry for recorded music purchase and users that buy the products of both industries.

A brief revision of the Music industry shows us this situation:

Artists are looking to Internet as a much more profitable distribution channel.

The Entertainment Industry is threatened by Internet based copy and distribution software (i.e. Napster), finding harder to protect its copyrights.

The Home Appliances Industry is nailed in the HIFI STEREO paradigm were innovation is coming from fancy designs.

Current paradigms don't allow artists and enterprises, to see that the “Listen to Music Experience” can be improved with the technology already available at a level that obsoletes current solutions, reshaping the entire industry.

General Industry and Technology Overview

Actual recording technology includes multiples tracks digital recording (32, 64 and over), where one microphone or more are assigned to each instrument obtaining a high fidelity digitally recorded track of each player. The tracks are mixed altogether into 2 separated record channels, RIGHT and LEFT, representing the “Stereo Music”

The assumption was that reproducing each record trough two high quality speakers, the music's sensation of profundity and volume would be reproduced. What hamper this technique are the multiple uncontrolled sound's reflections and attenuations that occurs at the reproduction site.

In order to reproduce music resembling accurately the site and atmosphere in which it was created, we need to deal with unlimited diverse reproductions sites.

Three facts support this invention:

There are no technological barriers that prevent music vendors to successfully deal with unlimited unique reproduction sites and multichannel music records.

Music vendors will produce unique versions for each customer's reproduction setup, creating barriers to the copyright infringement.

The art market and human nature have proven that the willingness to pay for an art manifestation is strongly correlated with its originality.

### BRIEF SUMMARY OF THE INVENTION

The invention is a Business Model for the sale of recorded media through the Internet and other distribution channels adapted to the customer's preferences and acoustic print and replay system's setup, the listening environment's acoustic characteristics and the sale's terms and conditions, comprising the recording, storage and sale of music and related performing arts (video clips, images, files, etc.).

This business model requires access to Internet, storage capacity for music files, multi-channel reproduction capability (a channel for each speaker available) and complementary device's control capabilities, an application or embedded capabilities to determine: the customer's preferences regarding music and related media experience and the acoustic characteristic of user's environment.

### BRIEF DESCRIPTION OF DRAWINGS

FIG. 1 presents a comparison between the current approach and the proposal.

FIG. 2 depicts the arquitecture of the Business Model.

FIG. 3 depicts the proposed Business Model process.

### DETAILED DESCRIPTION OF THE INVENTION

Preferred embodiment

Content Provider and/or Seller Master Records Data Base

The content provider and or seller database (Original Master Record or OMR) is an organized file of master sound tracks, videos and related data files.

Content Provider and/or Seller Applications

On top of commercially available e-commerce tools the seller should have an application able to produce a CMRF (Customized Multichannel Recording File) using the customer's profile and the OMR. The CMRF will be transferred to the user's reproducing device through Internet or other distribution channels and will be automatically created at the invented system considering:

The customer's purchased option

The customer's reproducer system's characteristics in terms of available channels, speakers type, available storage space, etc.

The customer's listening site acoustic characteristics.

Content Provider and/or Seller Web Interface

The preferred way to support the seller—customers' interactions and relationships is a commercial web site. Other set ups as call centers or physical stores also could be part of the chain.

Customer Reproduction Device

The reproduction function at the customer site could be supported in a PC or in a stand-alone device. In both cases the reproduction device will support:

Multiple attached speakers' control.

Environment's acoustic characteristics determination functions.

Multichannel sound tracks storage and reproduction.

Search and structured storage functions.

Reproduction's characteristics control: volume, reverberation, echo, tone, etc.

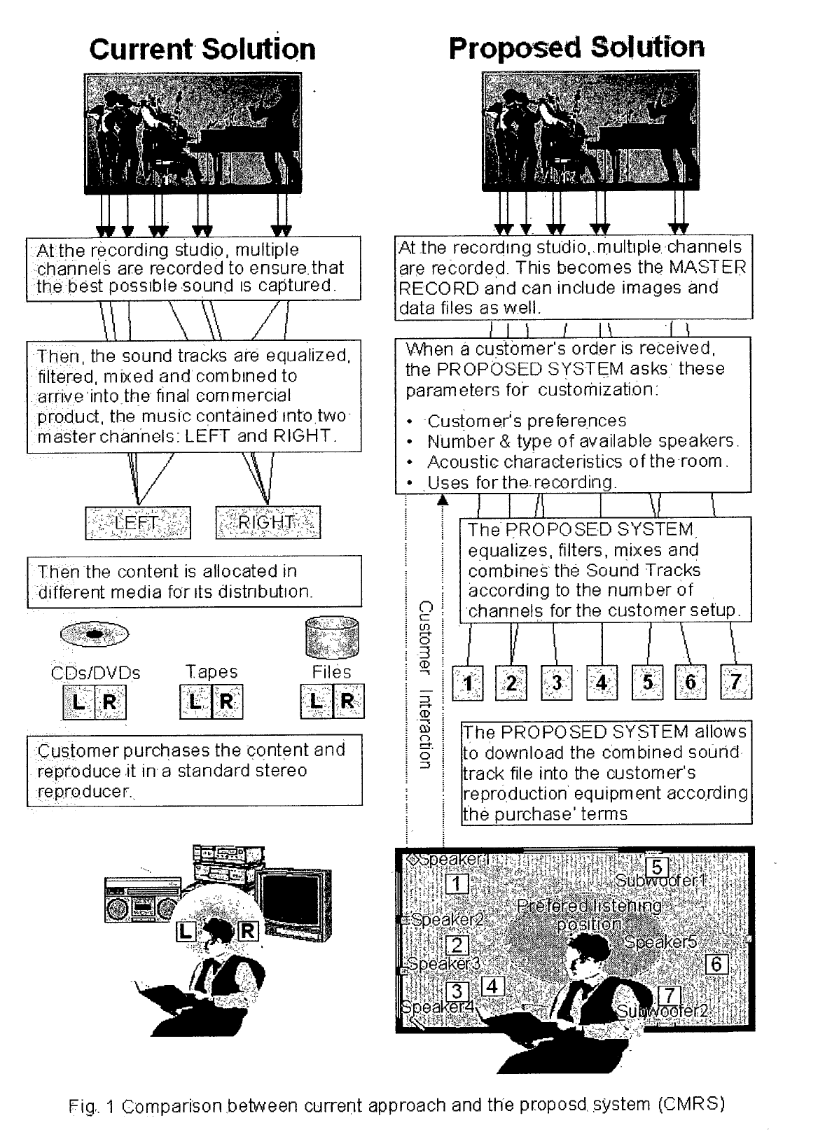

The speakers could be specialized, i.e. woods or drums or bronzes according the end user preferences or general purpose FIG. 1.

Conceptual Business Model

The innovations proposed are briefly explained in FIG. 1 “Business model comparison”. In the proposed model, the product is different, is comprised of a variable number of soundtracks adjusted according the customer's profile. The product has been created based on an interaction between the seller and the customer where the customer has provided a profile including his reproduction system's characteristics and the acoustic profile to generate the product.

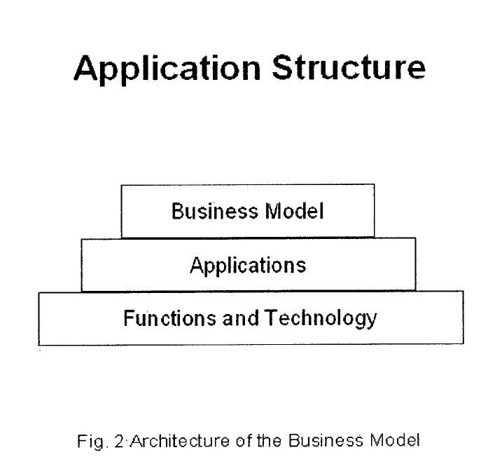

To develop this proposal, a 3-layered structure comprising a Business Model, Applications and Functions has been applied (FIG. 2).

Business Model: Defines the way in which value will be created and the main characteristics of the services and products that will be made available.

Applications: Describes a group of coordinated functions that support the business model.

Functions: Constitutes the basic building blocks that support the applications, closed related to techniques or devices. This level corresponds to the Technology layer.

Because to support the proposed business model all the Functions and Technologies needed are already available and the applications needed are just an integration job the patent application was done for the layer of the Business Model.

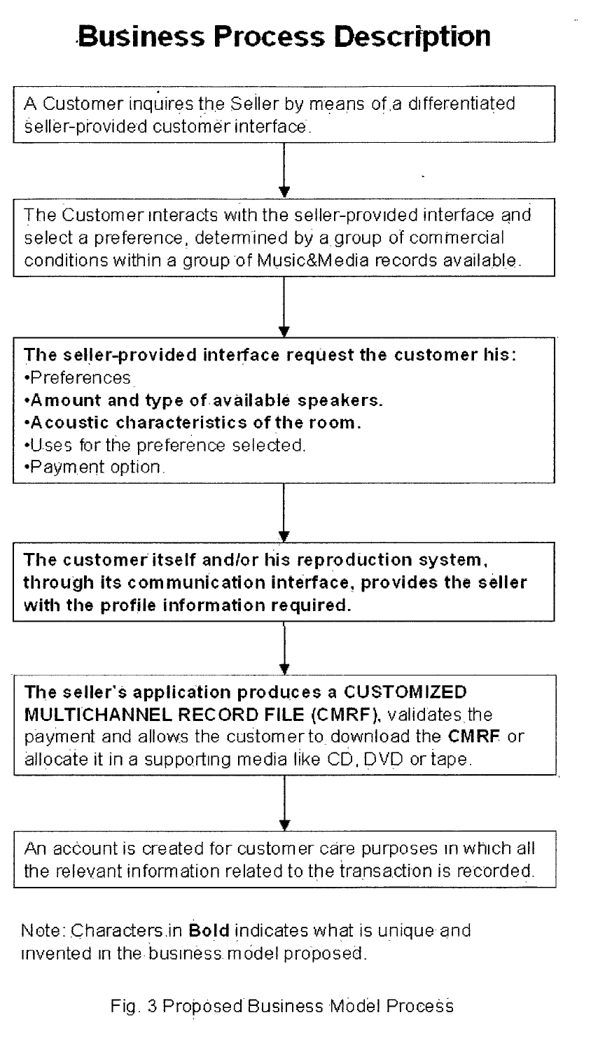

FIG. 3 describes the Business Model Process, specifying the transactions ocurred when an interaction between customer and seller takes place. The interaction starts with the customer's purchase of a music record, then is required by the seller to provide his preferences and the characteristics of his reproduction system and listening environment. The seller generates a Customized MultiChannel Record File (CMRF) and proceeds with the sale.

Invention Benefits

End User Experience Enhancement

Music and related industry (broadcast, storage, etc.) currently follow a massive approach, where a 2-channel version from a multichannel original recording is sold. This invention aims to expand the audio channels to as many as the customer's reproducer system could support, tailoring the record to his or her environmental acoustic characteristics. Other aid devices that could be controlled by the reproduction system to expand the customer's experience are lights, active sound absorption surfaces, computers, wireless devices, etc.

Purchasing Options and Artists Offerings Expansion

The CMRF opens a lot of new options to purchasers and sellers:

Sale/Purchase the rights to a limited or unlimited system profile adaptations according customers' reproduction system improvements.

Sale/Purchase a package of music to be used once at a party or event.

Sale/Purchase versions for Karaoke of voices or “Instruments” (authors could include partitures and tips for difficult passages).

Sale/Purchase limited amount version's rights, keeping at the seller's site the key file to be played on-line to obtain a coherent reproduction.

Sale/Purchase different quality levels.

Sale/Purchase versions for different devices (cellular phones, PDAs, car audio systems, etc.), derived from the customer edited CMRF.

The invention allows sellers to control the original master records, and users to keep customized copies. The proposal allows new customers' interactions (i.e. customers can propose his own version for certain channels of the recording) and new ways to increase his or her loyalty and the product's life cycle.

Pirate Distribution of Copyrights Materials Restriction

As customer's preferences, reproducer systems and environmental acoustic characteristics generates uniques CMRFs, the invention hinders piracy by:

Offering quality versions differentiated from unauthorized copies.

Limiting the access to the original records.

Sharped price discrimination through quality levels, according purchaser's willingness to pay.

Increasing customer interaction and loyalty.

Commercial Technology to Support the Invention

The technologies that support this type of business model are not being integrated in a commercial available product. Dividing the different process that the invented system supports we obtain:

ORIGINAL RECORDING PROCESS. In general all the technology is available and in commercial use.

CREATION OF CMRFs. The software needs to be created and supported on currently available commercial hardware and software.

INTERNET BASED BUSINESS MODEL SUPPORT. The business rules needs to be created and supported on currently available commercial hardware and software.

MULTICHANNEL STORAGE AND REPRODUCTION SYSTEMS CONNECTED TO INTERNET. Currently available audio and computer technology needs to be integrated to create this type of devices. Also the acoustic print determination function must be incorporated in this device.

SPECIALIZED SPEAKERS AND OTHER COMPLEMENTS. For the speakers, video reproducers and lights control most of the technology is available. For active sound absorption devices technology must be developed.

Similar Business Model or Supporting Technologies in the Market

Up to my current knowledge the audio reproducing technologies that could have some similarities with the ones required to support CMRFs are DTS, Digital sound system developed by Lucas Art and focused on movie sound reproduction at the cinema and THX with similar scope. No one of these systems consider a customizing interaction and/or the creation of multiple different versions for multiple different customers requirements.

The main similarities arises form the fact that this systems looks for improve the customer experience.

What is claimed is:

1. What I claim as my invention is the method of sale to a customer a version of a performing art record, mainly but no limited to music, video and data files, that has been derived from a master record and specially customized to fit the customer's reproducer device and acoustic profile of the reproducer's location. Customization could also involve sales conditions and/or customers uses and/or customers preferences.

2. What I claim as my invention is the combination of the multiple sound tracks, video files and data files available in an original performing art record into a customized group of sound, video and data files that fits the customer's reproducer device and acoustic profile of the reproducer's location to enrich the customer experience and meet the sales conditions and/or customers uses and/or customers preferences.
